(19) United States
(12) Patent Application Publication
(10) Pub. No.: US 2012/0256962 A1
(43) Pub. Date: Oct. 11, 2012

(54) Video Processing Apparatus and Method for Extending the Vertical Blanking Interval

(75) Inventor: Shang-Chieh Wen, Tainan City (TW)

(73) Assignee: HIMAX MEDIA SOLUTIONS, INC., Tainan City (TW)

(21) Appl. No.: 13/081,798

(22) Filed: Apr. 7, 2011

(51) Int. Cl. G09G 5/00

(52) U.S. Cl. 345/660

(57) ABSTRACT

A video processing apparatus. A first scaling module receives original images according to an original pixel clock and performs adjustments on the original images according to a first scaling ratio to generate first scaled images. A frame buffer buffers the first scaled images. A controller controls the frame buffer to receive the first scaled images according to a first pixel clock and output the first scaled images according to a second pixel clock. A second scaling module receives the first scaled images and performs adjustments on the first scaled images according to a second scaling ratio to generate second scaled images. A length of a vertical blanking interval of the second scaled images is longer than a length of a vertical blanking interval of the original images.

### BACKGROUND OF THE INVENTION

1. Field of the Invention

The invention relates to a video processing apparatus and method, and more particularly to a video processing apparatus and method capable of extending a vertical blanking interval of video data and further reducing bandwidth consumption required by data access after extending the vertical blanking interval.

2. Description of the Related Art

With the development of technology, a display apparatus can now process and display various types of a video signals regardless of whether it is of digital or analog origins. Further, watching a stereoscopic image based on a 3-dimensional video signal (hereinafter, referred to as a “stereoscopic video signal”) through a monitor, a television or other display apparatuses, has recently become possible. In general, the stereoscopic video signal has contents divided corresponding to left and right eyes of a user as opposed to a two-dimensional video signal (hereinafter, referred to as a “plane” video signal). Also, the contents are displayed as divided images corresponding to the left and right eyes of a user, respectively.

Thus, to enable a user to experience the stereoscopic image based on the images being divided to the left and right eyes, a polarized-glass method and a shutter-glass method are employed. The polarized-glass method uses a phase-difference filter and the shutter-glass method displays left and right images alternately by switching a shutter on and off. The shutter-glass is generally turned on during the vertical blanking interval. However, a major problem in using the shutter-glass is that the vertical blanking interval is generally very short, so that the perceived stereoscopic images are not bright enough.

To solve this problem, a video processing apparatus capable of extending a vertical blanking interval of video data and further reducing bandwidth consumption required by data access after extending the vertical blanking interval is proposed.

### BRIEF SUMMARY OF THE INVENTION

Video processing apparatuses and video processing methods are provided. An exemplary embodiment of a video processing apparatus comprises a first scaling module, a frame buffer and a controller. The first scaling module receives a plurality of original images according to an original pixel clock and performs adjustments on the original images according to a first scaling ratio to generate a plurality of first scaled images. The frame buffer is coupled to the first scaling module to buffer the first scaled images. The controller controls the frame buffer to receive the first scaled images according to a first pixel clock and output the first scaled images according to a second pixel clock. A length of a vertical blanking interval of the first scaled images outputted by the frame buffer is longer than a length of a vertical blanking interval of the original images.

Another exemplary embodiment of a video processing method comprises: performing adjustments on a plurality of original images according to a first scaling ratio to generate a plurality of first scaled images; receiving the first scaled images according to a first pixel clock and buffering the first scaled images in a frame buffer; outputting the first scaled images from the frame buffer according to a second pixel clock; and performing adjustments on the first scaled images according to a second scaling ratio to generate a plurality of second scaled images, wherein a length of a vertical blanking interval of the second scaled images is longer than a length of a vertical blanking interval of the original images.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a block diagram of a video processing apparatus according to an embodiment of the invention;

FIG. 2 is a schematic diagram showing the changes in the vertical active interval and vertical blanking interval of the images processed by the video processing apparatus 100 according to an embodiment of the invention;

FIG. 3 is a schematic diagram showing the changes in the vertical active interval and vertical blanking interval of the images processed by the video processing apparatus 100 according to another embodiment of the invention; and

FIG. 4 shows a flow chart of a video processing method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

As previously described, a major problem when using the shutter-glass for stereoscopic images is that the vertical blanking intervals (VBI) of the stereoscopic images or video data are generally very short, so that the perceived stereoscopic images or video data are not bright enough. One solution is to increase the pixel clock so as to achieve VBI extension. To be more specific, as the pixel clock is increased, the active data may be output according to a higher clock rate, so as to shrink the vertical active interval and relatively extend the vertical blanking interval. However, the increase in the pixel clock also causes bandwidth consumption to increase, as well as accessing the memory for storing frame data is required. For example, suppose that the pixel clock is increased by 30%, then the vertical blanking interval may accordingly have a 30% extension, and the bandwidth consumption required for data access would also increased by 30% due to the increase in the pixel clock. In order to prevent the bandwidth consumption from increasing after performing a VBI extension, a novel architecture of a video processing apparatus and a corresponding video processing method are proposed.

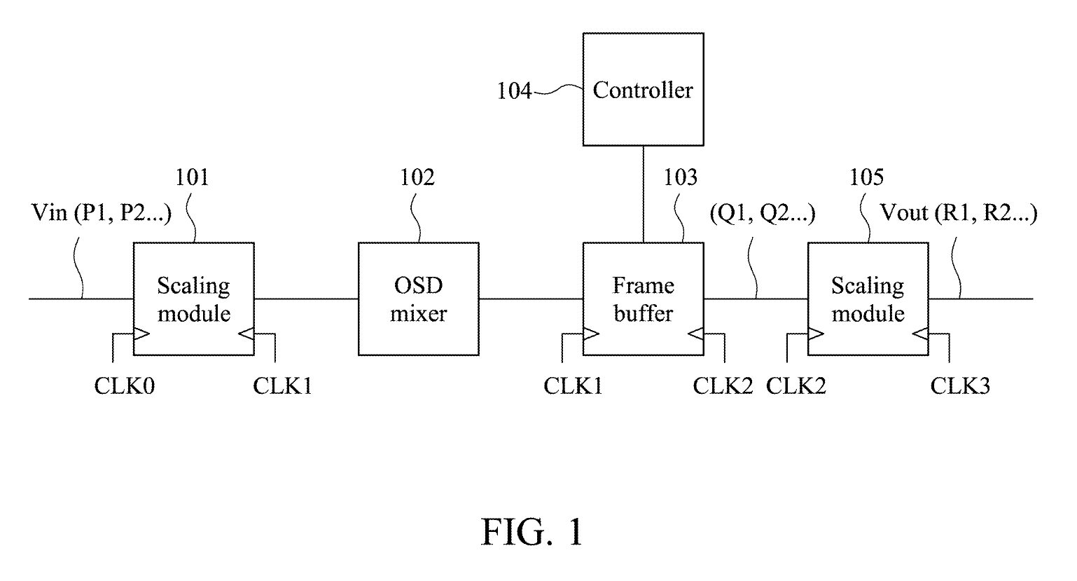

FIG. 1 shows a block diagram of a video processing apparatus according to an embodiment of the invention. The video processing apparatus 100 comprises a first scaling module 101, an on screen display (OSD) mixer 102, a frame buffer 103, a controller 104 and a second scaling module 105. The first scaling module 101 receives an input video data Vin from a host, wherein the host may be a computer, a graphic processing unit (GPU), a video data provider, or the likes. The input video data Vin may comprise a plurality of original images (P1, P2 . . . etc.), where the original images (P1, P2 . . . etc.) may be un-divided images, or may alternately be divided left and right images, and the invention is not limited to either case. The first scaling module 101 may perform adjustments on the original images according to a first scaling ratio to generate a plurality of first scaled images.

According to an embodiment of the invention, the first scaling module 101 may be a down-scaling module. Therefore, in one embodiment of the invention, the first scaling ratio may be smaller than 1. For example, the first scaling ratio may be 2/3, so that the dimensions of the original images may be scaled down by 1/3. Note that in the embodiments of the invention, an aspect ratio of the original images is preferably left unchanged after performing the scaling operation. Therefore, the aspect ratio of the original images and the first scaled images would be the same. For example, suppose that the resolution of the original images is M*N, and the resolution of the first scaled images output by the first scaling module 101 is X*Y, then the aspect ratio (M:N) would be equal to (X:Y), where M, N, X and Y are positive integers.

As shown in FIG. 1, the first scaling module 101 may receive the original images according to an original pixel clock CLK0 of the input video data Vin, perform the scaling operations on the original images according to the first scaling ratio, and output the first scaled images according to a first pixel clock CLK1. Note that according to the embodiments of the invention, the pixel clock of the images is accordingly changed with the scaling operations. For example, suppose that the original pixel clock CLK0 of the input video data Vin is 300 MHz and the first scaling ratio is 2/3, after the scaling operations, the first pixel clock CLK1 for outputting the first scaled images would be 300*(2/3)=200 MHz. Therefore, the first scaling module 101 would output the first scaled images according to the first pixel clock CLK1.

According to an embodiment of the invention, the first scaled images (with or without the OSD image superimposed thereon, which will be discussed in more detailed in the following paragraphs) may be passed to the frame buffer 103 for performing of the VBI extension. In order to extend the vertical blanking interval of the video data, the controller 104 may control the frame buffer 103 to receive the first scaled images according to the first pixel clock CLK1, and output the first scaled images according to a second pixel clock CLK2. Generally, the second pixel clock CLK2 is higher than the first pixel clock CLK1, and a ratio of the second pixel clock CLK2 to the first pixel clock CLK1 relates to the required amount of the VBI extension. According to an embodiment of the invention, when it is desired to extend the length of the original vertical blanking interval by 30%, then the second pixel clock CLK2 may be obtained by CLK1*(1+30%). For example, when the first pixel clock CLK1=200 MHz, the second pixel clock CLK2 may be obtained by 200*1.3=260 MHz. With 30% of the pixel clock overhead, 30% of the VBI extension may be achieved.

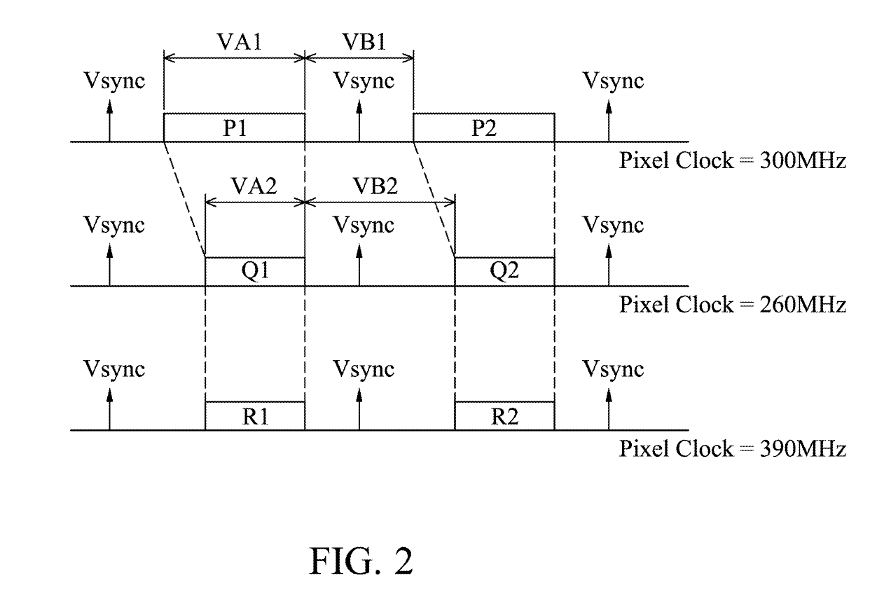

FIG. 2 is a schematic diagram showing the changes in the vertical active interval and vertical blanking interval of the images processed by the video processing apparatus 100 according to an embodiment of the invention. In the first row of FIG. 2, the original images (P1, P2 . . . etc.) comprised in the input video data Vin are presented. The vertical synchronization signal Vsync defines the frame rate of the video data, and VA1 represents the vertical active interval and VB1 represents the vertical blanking interval of the original images P1, P2 . . . etc. comprised in the input video data Vin. In the second row of FIG. 2, the first scaled images (Q1, Q2 . . . etc.) are outputted by the frame buffer 103 with an extended vertical active interval VB2 as compared to the original vertical active interval VB1 of the original images shown in the first row. Note that after the VB1 extension is performed in the frame buffer 103, a length of a vertical blanking interval VB2 of the first scaled images (Q1, Q2 . . . etc.) outputted by the frame buffer 103 is longer than the length of the vertical blanking interval of the original images (P1, P2 . . . etc.).

According to an embodiment of the invention, the frame buffer 103 may be implemented by any type of memory device, for example, but not limited to, a DRAM device. The controller 104 and the frame buffer 103 may be individual hardware modules or may be integrated as a single module, or other module architectures, thus, the invention should not be limited to either case. As previously described, conventionally, when the vertical blanking interval has a 30% extension by increasing 30% of the pixel clock, the bandwidth consumption is also increased by 30% due to the increase in the pixel clock. For example, in a conventional approach, a 30% VBI extension may be achieved by increasing the pixel clock from 300 MHz to 390 MHz. Therefore, the bandwidth consumption required when accessing the video data stored in the frame buffer is increased to 390 MHz. However, in the embodiments of the invention as previously described, when the original pixel clock of the input video data Vin is 300 MHz (i.e., CLK0), the required pixel clock CLK2 for outputting data from the frame buffer 103 is reduced to 260 MHz. Therefore, the bandwidth consumption required when accessing the video data stored in the frame buffer is greatly reduced to be much lower than the conventionally required 390 MHz after the 30% VBI extension.

Referring back to FIG. 1, according to an embodiment of the invention, the second scaling module 105 may further perform adjustments on the first scaled images (Q1, Q2 . . . etc.) received from the frame buffer 103 according to a second scaling ratio, so as to generate a plurality of second scaled images (R1, R2 . . . etc.), where the second scaled images (R1, R2 . . . etc.) are comprised in the output video data Vout. According to an embodiment of the invention, the second scaling module 105 may be an up-scaling module. Therefore, in one embodiment of the invention, the second scaling ratio may be larger than 1. For example, the second scaling ratio may be 3/2, which is a reciprocal of the first scaling ratio. Note that in the embodiments of the invention, an aspect ratio of the original images is preferably left unchanged after performing the scaling operations. Therefore, the aspect ratio of the original images and the second scaled images are the same. As an example, suppose that the resolution of the original images (P1, P2 . . . etc.) is M*N, then the resolution of the second scaled images (R1, R2 . . . etc.) after up-scaling would be M*N.

As shown in FIG. 1 the second scaling module 105 may receive the first scaled images from the frame buffer 103 according to the second pixel clock CLK2, perform the scaling operations on the first scaled images according to the second scaling ratio, and output the second scaled images according to a third pixel clock CLK3. Note that according to the embodiments of the invention, the pixel clock of the images is accordingly changed with the scaling operations. Therefore, the second scaling module 105 may output the second scaled images according to the third pixel clock CLK3. For example, suppose that the second pixel clock CLK2 is 260 MHz after the VBI extension and the second scaling ratio is 3/2, then after the scaling operations, the third pixel clock CLK3 required for outputting the second scaled images may be obtained by 260*(3/2)=390 MHz.

Referring to the third row of FIG. 2, the second scaled images (R1, R2 . . . etc.) output by the second scaling module 105 are presented. As shown in FIG. 2, a length of a vertical blanking interval of the second scaled images (R1, R2 . . . etc.) is longer than a length of a vertical blanking interval of the original images (P1, P2 . . . etc.), and the pixel clock is increased to 390 MHz due to the up-scaling operations. Note that according to the embodiments of the invention, a ratio of vertical blanking interval to the vertical active interval may be left unchanged after the scaling operations (see the second and third rows in FIG. 2). Therefore, the obtained second scaled images would have the same required amount (for example, 30%) of VBI extension.

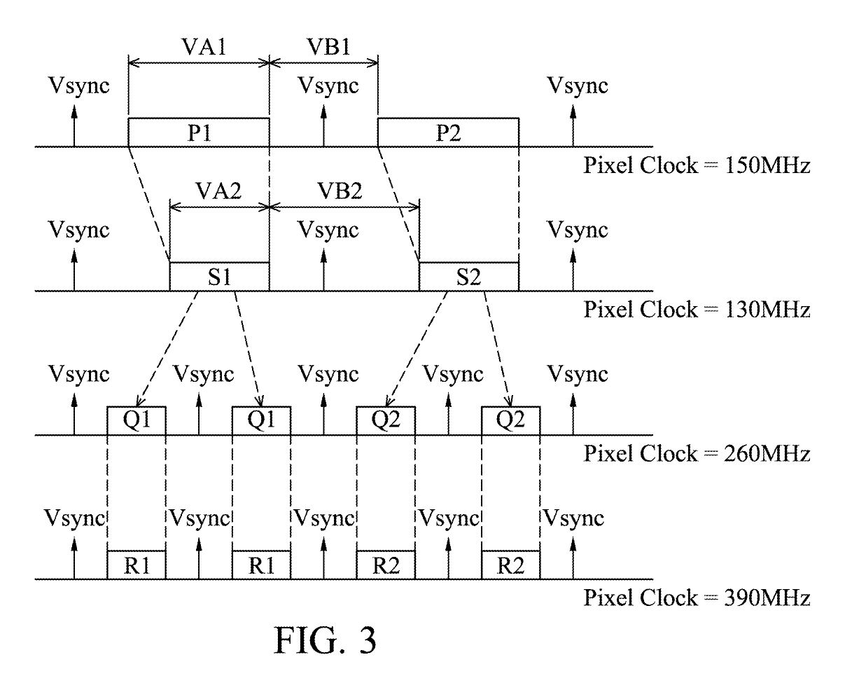

According to another embodiment, the controller 104 may further perform frame rate conversion (FRC) on the first scaled images. For example, when the original images (P1, P2 . . . etc.) are un-divided images or alternate left and right images with a frame rate of 60 Hz, frame rate conversion is required so as to convert the frame rate to a level suitable for displaying stereoscopic images. The frame rate conversion may be preformed by, for example, doubling the original frame rate (e.g. from 60 Hz to 120 Hz). FIG. 3 is a schematic diagram showing the changes in the vertical active interval and vertical blanking interval of the images processed by the video processing apparatus 100 according to another embodiment of the invention. In the first row of FIG. 3, the original images (P1, P2 . . . etc.) comprised in the input video data Vin with 60 Hz frame rate and 150 MHz pixel clock are presented. Also, the vertical synchronization signal Vsync defines the frame rate of the video data, and VA1 represents the vertical active interval and VB1 represents the vertical blanking interval of the original images P1, P2 . . . etc. comprised in the input video data Vin.

In the second row of FIG. 3, the images (S1, S2 . . . etc.), which are 1/3 down-scaled in dimension and have a 30% VBI extension are presented, where the pixel clock may be obtained by 150*2/3*(1+30%)=130 MHz. Note that after the VBI extension, a length of a vertical blanking interval VB2 of the images (S1, S2 . . . etc.) is longer than the length of the vertical blanking interval of the original images (P1, P2 . . . etc.).

In the third row of FIG. 3, the images (Q1, Q1, Q2, Q2, . . . etc.) output by the frame buffer 103 with frame rate conversion are presented, where the frame rate conversion may be obtained by outputting each of the first scaled images twice according to two times the frequency of the second pixel clock. Therefore, as shown in the third row of FIG. 3, the images Q1 may be the duplicated versions of the image S1, and the images Q2 may be the duplicated versions of the image S2, and so on. The obtained frame rate may be doubled from 60 Hz to 120 Hz after frame rate conversion, where the pixel clock would also be doubled from 130 MHz to 260 MHz. It should be noted that although the frame rate conversion shown in FIG. 3 is implemented by duplicating the images so as to double the frame rate, the invention should not be limited thereto. As one of ordinary skill in the art will readily appreciate, the frame rate conversion may also be implemented by any other algorithm to achieve substantially the same results as described in the embodiments of the invention. It should also be noted that although the frame rate conversion shown in FIG. 3 is implemented after the VBI extension, the invention should not be limited thereto. As one of ordinary skill in the art will readily appreciate, under the proposed video processor architecture, the frame rate conversion may also be performed before the VBI extension, thus, the invention should not be limited to either case.

Referring to the fourth row of FIG. 3, the second scaled images (R1, R1, R2, R2 . . . etc.) outputted by the second scaling module 105 are presented. As shown in FIG. 3, the pixel clock is increased to 390 MHz due to the up-scaling operations. Note that according to the embodiments of the invention, a ratio of vertical blanking interval to the vertical active interval may be left unchanged after the scaling operations. Therefore, the obtained second scaled images would have the same required amount (for example, 30%) of VBI extension.

According to yet another embodiment, when needed, one or more OSD images are preferably superimposed on the first scaled images before performing a VBI extension (and frame rate conversion). Referring back to FIG. 1, the OSD mixer 102 is coupled between the first scaling module 101 and the frame buffer 103 to superimpose the OSD image on the first scaled images. Because mixing the OSD images also requires the memory to be accessed and the bandwidth consumption, by arranging the OSD mixer 102 to be in front of the frame buffer 103, the OSD mixer 102 may not have to mix the OSD image with the first scaled images under high pixel clock and frame rate as compared to arrange the OSD mixer 102 to be in back of the frame buffer 103.

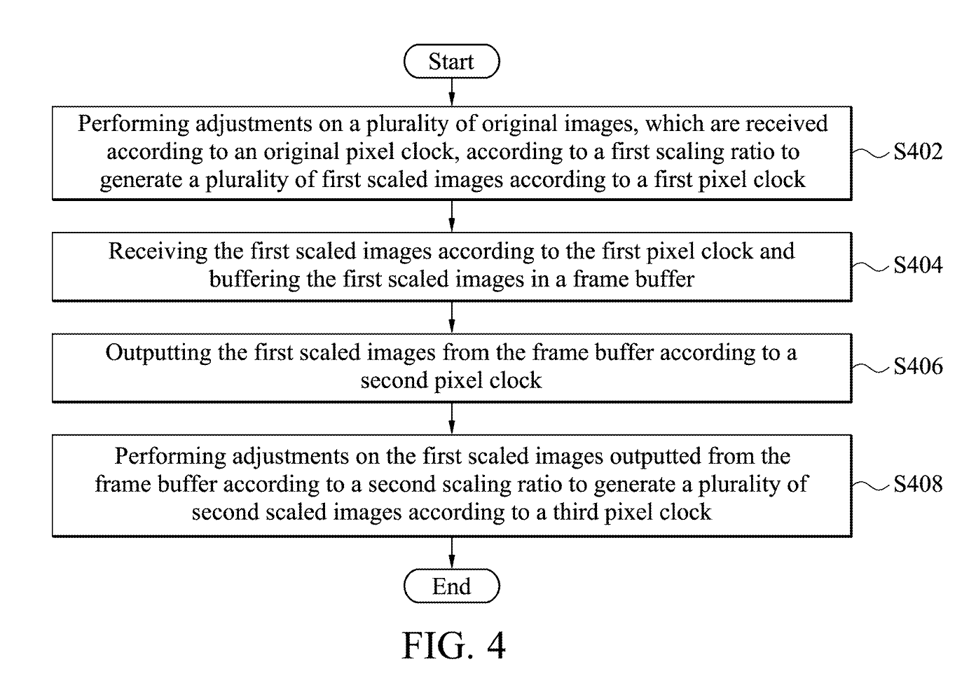

FIG. 4 shows a flow chart of a video processing method according to an embodiment of the invention. To begin, in step S402, adjustments on a plurality of original images, which are received according to an original pixel clock, is performed according to a first scaling ratio to generate a plurality of first scaled images according to a first pixel clock. A ratio of the first pixel clock to the original pixel clock equals to the first scaling ratio. Next, in step S404, a frame buffer is utilized for receiving the first scaled images according to the first pixel clock and buffering the first scaled images therein. Next, in step S406, the frame buffer is further utilized for outputting the first scaled images according to a second pixel clock. Finally, in step S408, adjustments on the first scaled images outputted from the frame buffer are performed according to a second scaling ratio to generate a plurality of second scaled images according to a third pixel clock. A ratio of the third pixel clock to the second pixel clock equals to the second scaling ratio. By properly selecting values of the first scaling ratio, the second scaling ratio, the first pixel clock and the second pixel clock, the lengths of the vertical blanking intervals of the first and second scaled images can be extended, and the bandwidth consumption required by accessing the frame buffer after extending the vertical blanking interval can be reduced.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A video processing apparatus, comprising:
a first scaling module, receiving a plurality of original images according to an original pixel clock and performing adjustments on the original images according to a first scaling ratio to generate a plurality of first scaled images;
a frame buffer, coupled to the first scaling module to buffer the first scaled images; and
a controller, controlling the frame buffer to receive the first scaled images according to a first pixel clock and output the first scaled images according to a second pixel clock,
wherein a length of a vertical blanking interval of the first scaled images outputted by the frame buffer is longer than a length of a vertical blanking interval of the original images.

2. The video processing apparatus as claimed in claim 1, further comprising:
a second scaling module, receiving the first scaled images from the frame buffer and performing adjustments on the first scaled images according to a second scaling ratio to generate a plurality of second scaled images,
wherein a length of a vertical blanking interval of the second scaled images is longer than the length of the vertical blanking interval of the original images.

3. The video processing apparatus as claimed in claim 1, wherein the first scaling module is a down-scaling module and outputs the plurality of first scaled images according to the first pixel clock, wherein a ratio of the first pixel clock to the

4. The video processing apparatus as claimed in claim 2, wherein the second scaling module is an up-scaling module and outputs the plurality of second scaled images according to a third pixel clock, wherein a ratio of the third pixel clock to the second pixel clock equals to the second scaling ratio.

5. The video processing apparatus as claimed in claim 2, wherein the second scaling ratio is a reciprocal of the first scaling ratio.

6. The video processing apparatus as claimed in claim 1, wherein a ratio of the length of the vertical blanking interval of the first scaled images outputted by the frame buffer to the length of the vertical blanking interval of the original images equals to a ratio of the second pixel clock to the first pixel clock.

7. The video processing apparatus as claimed in claim 2, wherein a ratio of the length of the vertical blanking interval of the second scaled images to the length of the vertical blanking interval of the original images equals to a ratio of the second pixel clock to the first pixel clock.

8. The video processing apparatus as claimed in claim 1, further comprising:
an on screen display (OSD) mixer, coupled between the first scaling module and the frame buffer for superimposing an OSD image on the first scaled images.

9. The video processing apparatus as claimed in claim 1, wherein the controller further performs frame rate conversion on the first scaled images by controlling the frame buffer to output each of the first scaled images twice according to two times the frequency of the second pixel clock.

10. The video processing apparatus as claimed in claim 2, wherein an aspect ratio of the original images, the first scaled images and the second scaled images are the same.

11. A video processing method, comprising:
performing adjustments on a plurality of original images according to a first scaling ratio to generate a plurality of first scaled images;
receiving the first scaled images according to a first pixel clock and buffering the first scaled images in a frame buffer;
outputting the first scaled images from the frame buffer according to a second pixel clock; and
performing adjustments on the first scaled images according to a second scaling ratio to generate a plurality of second scaled images,
wherein a length of a vertical blanking interval of the second scaled images is longer than a length of a vertical blanking interval of the original images.

12. The video processing method as claimed in claim 11, wherein the first scaling ratio is smaller than 1.

13. The video processing method as claimed in claim 11, wherein the second scaling ratio is larger than 1.

14. The video processing method as claimed in claim 11, wherein the second scaling ratio is a reciprocal of the first scaling ratio.

15. The video processing method as claimed in claim 11, wherein a length of a vertical blanking interval of the first scaled images outputted by the frame buffer is longer than the length of the vertical blanking interval of the original images.

16. The video processing method as claimed in claim 11, wherein a ratio of the length of the vertical blanking interval of the second scaled images to the length of the vertical blanking interval of the original images equals to a ratio of the second pixel clock to the first pixel clock.

17. The video processing method as claimed in claim 11, wherein a ratio of a buffer to the length of the vertical blanking interval of the original images equals to a ratio of the second pixel clock to the first pixel clock.

18. The video processing method as claimed in claim 11, further comprising:
superimposing an OSD image on the first scaled images before buffering the first scaled images in the frame buffer.

19. The video processing method as claimed in claim 11 further comprising:
performing frame rate conversion on the first scaled images by outputting each of the first scaled images from the frame buffer twice according to two times the frequency of the second pixel clock.

20. The video processing method as claimed in claim 11, wherein an aspect ratio of the original images, the first scaled images and the second scaled images are
